(19) United States
(12) Patent Application Publication
(10) Pub. No.: US 2012/0163479 A1
(43) Pub. Date: Jun. 28, 2012

(54) METHODS AND DEVICES FOR FILTERING AND CODING A DIGITAL SIGNAL

(75) Inventors: Christophe Gisquet, Rennes (FR); Félix Henry, Rennes (FR)

(73) Assignee: CANON KABUSHIKI KAISHA, Tokyo (JP)

(21) Appl. No.: 13/394,520

(22) PCT Filed: Sep. 28, 2010
(86) PCT No.: PCT/IB10/54360

§ 371 Date: Mar. 6, 2012

(30) Foreign Application Priority Data
Sep. 28, 2009 (FR) 0956714

(51) Int. Cl. H04N 7/26

(52) U.S. Cl. 375/240.29; 375/E07.193

(57) ABSTRACT

The method of filtering at least one group of at least one sample of a digital signal comprises a step of initializing current values of coefficients associated with each filter support, and, for at least two iterations, for each group of samples: for each sample, determining a filter support, filtering the samples in the group with this filter support and the current coefficients, for each filter support: obtaining, among the samples, a subgroup of samples corresponding to the filter support, and determining optimal values of the coefficients of the filter associated with said support according to a predetermined criterion, each iteration, as from the second, using as current values of coefficients the optimal values of coefficients of the previous iteration.

The present invention concerns methods and devices for filtering and coding signals composed of samples. It applies in particular to a method and device for the conjoint optimization of the orientations and coefficients of filters for filtering pictures.

When filtering of a picture is carried out, several means can be used for improving its efficacy: the filter can be oriented to make it correspond to the content of the picture (border or corner, for example) and the response of the filter, the coefficients of a convolution filter for example, can be adapted to statistics relating to the picture.

In general terms, using filtering so as to refine a source signal in order to approximate it to a known target signal according to a criterion is known in the prior art. In a coding context, a criterion based on a rate/distortion compromise is generally used, using the conjoint minimization of the distortion between the source signal and the target signal and the rate of the data to be coded in order to obtain on decoding a signal approximating the target signal from the source signal. This refinement tends to minimize the distortion between source picture and original picture. This type of filtering finds a particularly advantageous application in the supersampling of a picture or video in order to approximate it to a target picture or video of higher resolution.

The present invention aims, among other things, to improve the rate-distortion compromise when such a filtering is applied.

To the end, according to a first aspect, the present invention relates to a method of filtering at least one group of at least one sample of a digital signal, a filter being defined by a support in a predetermined set of supports defining samples associated with each sample to be filtered and a set of coefficients associated with said samples defined by the support, which comprises a step of initializing current values of coefficients associated with each filter support, characterized in that it comprises, for at least two iterations, for each group of samples:
for each sample to be filtered, a step of determining a filter support to be applied to said sample,
a step of filtering the samples in said group of samples using said support and said current coefficient values,
for each filter support:
   a step of obtaining, from the samples in said group, a sub-group of samples comprising each sample in the group of samples corresponding to said filter support, and
   a step of determining optimal values of the coefficients of the filter associated with said support according to a predetermined criterion applied to said sub-group of samples,
      each iteration, as from the second, using, as current coefficient values, the optimal values of coefficients obtained during the previous iteration.

By the implementation of the present invention, the choice of the support and coefficients of the filter associated with each sample are conjointly optimized.

According to particular features, the samples correspond to picture pixels, each iteration being performed for a group of at least one picture.

By implementation of the present invention, the picture or video can be enhanced, and in particular supersampled, using the optimized filter and give better fidelity than with the other filtering schemes using linear or non-linear interpolations.

According to particular features, during at least one initialization step, for at least one group of at least one picture to be filtered, the current values of the coefficients are initialized to the optimal values determined for at least one picture in a group not containing said picture to be filtered.

By virtue of this feature, the initialization is particularly easy for a sequence of pictures.

According to particular features, during each iteration, the pictures are processed by groups each comprising a plurality of successive pictures.

Thus the method is particularly easy to implement with video coding formats that process the pictures by groups of pictures (GOPs).

According to particular features, during each iteration, co-located blocks in successive pictures in the same group of pictures are processed successively.

According to particular features, the supports of the predetermined set of supports correspond to filter orientations.

Advantageously, the use of oriented filters makes it possible to take into account the contours and flat zones of the pictures in order better to adapt to the local characteristics of the pictures during filtering.

According to particular features, the supports in the predetermined set of supports have the same number of samples.

Thus implementation of the filtering method is simplified.

According to particular features, during at least one iteration, statistics are collected concerning the filtered samples and target values for the filtered samples, said statistics being used during the step of determining optimal values of the filter coefficients.

By virtue of this feature, the filtering is adapted dynamically to the data being processed.

According to particular features, during the step of determining optimal values of the coefficients of filters associated with said support according to a predetermined criterion, said predetermined criterion corresponds to the minimization of the mean square error between the values of the filtered samples and the target values of the filtered samples for a set of samples.

According to a second aspect, the present invention relates to a coding method using the method of filtering samples of a digital signal that is the subject matter of the present invention, which comprises a step of coding a subsampled signal representing said samples and a step of coding, in an auxiliary information unit, the supports and coefficients obtained during the last iteration of the filtering method.

Thus, the filtering method making it possible to conjointly optimize the choice of the support and the coefficients of the filter associated with each sample, the associated coding method is advantageous in terms of rate/distortion.

According to a third aspect, the present invention relates to a device for filtering at least one group of at least one sample of a digital signal, a filter being defined by a support in a predetermined set of supports defining samples associated with each sample to be filtered and a set of coefficients associated with samples defined by the support, which comprises a means of initializing current values of coefficients associated with each filter support, characterized in that it comprises optimization means adapted, during at least two iterations, for each group of samples:
for each sample to be filtered, to determine a filter support to be applied to said sample,
to filter the samples of said group of samples using said support and said current values of coefficients,
for each filter support:
   to obtain, from the samples in said group, a sub-group of samples comprising each sample in the group of samples corresponding to said filter support, and
   to determine optimal values of the coefficients of the filter associated with said support according to a predetermined criterion applied to said sub-group of samples,
      each iteration, as from the second, using as current values of coefficients the optimal values of coefficients of the previous iteration.

According to a fourth aspect, the present invention relates to a coding device comprising a device for filtering samples of a digital signal that is the subject matter of the present invention and a means of coding, in an auxiliary information unit, supports and coefficients obtained during the last iteration performed by the optimization means.

According to a fifth aspect, the present invention relates to a computer program that can be loaded into a computer system, said program containing instructions for implementing the method that is the subject matter of the present invention, as succinctly disclosed above.

According to a sixth aspect, the present invention relates to an information carrier that can be read by a computer or microprocessor, removable or not, storing instructions of a computer program, characterized in that it allows the implementation of the method that is the subject matter of the present invention, as succinctly disclosed above.

The particular advantages, aims and features of this filtering device, of this coding device, of this program and of this information carrier being similar to those of the filtering method that is the subject matter of the present invention, they are not repeated here.

Other advantages, aims and features of the present invention will emerge form the following description given, for an explanatory and in no way limitative purpose, with regard to the accompanying drawings, in which:

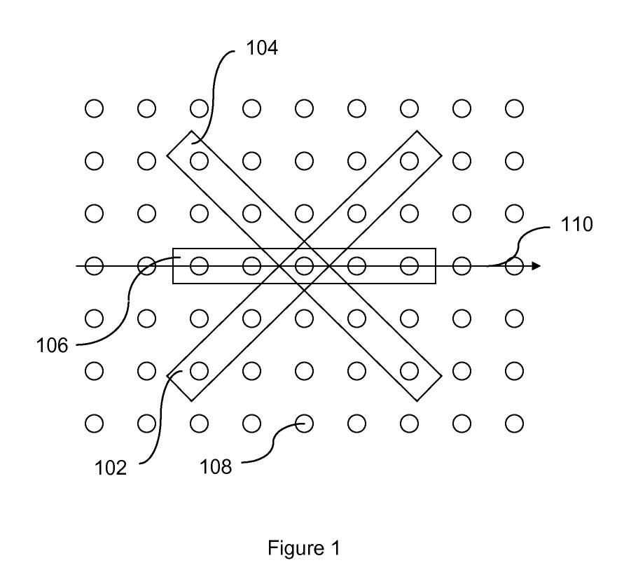

FIG. 1 shows, schematically, orientations of filters,

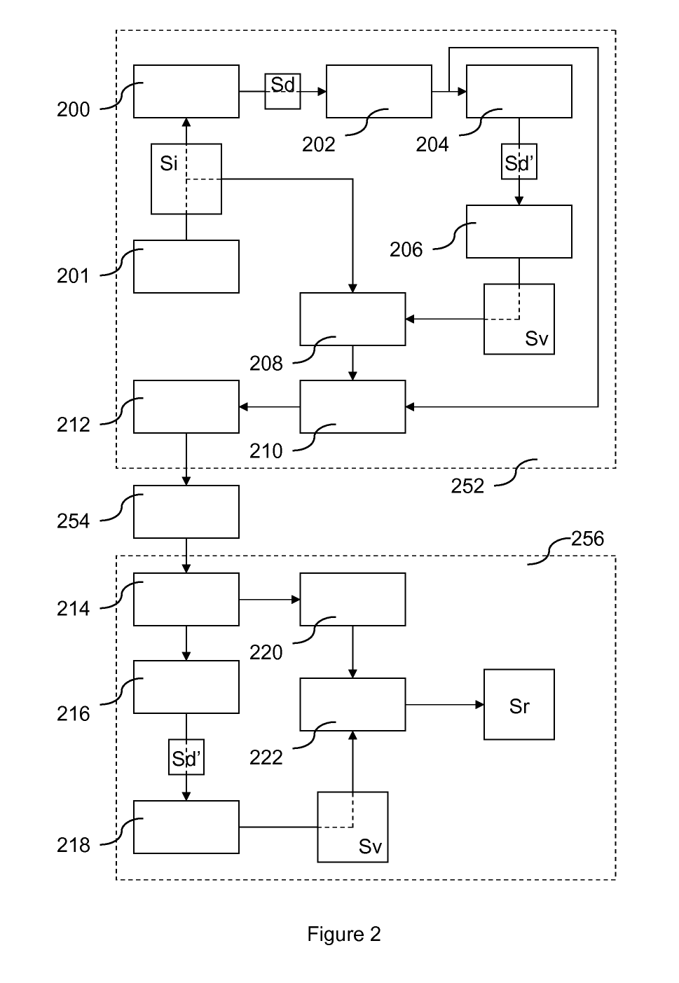

FIG. 2 shows, schematically, in the form of functional blocks, processing operations apply to an image in a particular embodiment of the methods and devices that are the subject of the present invention,

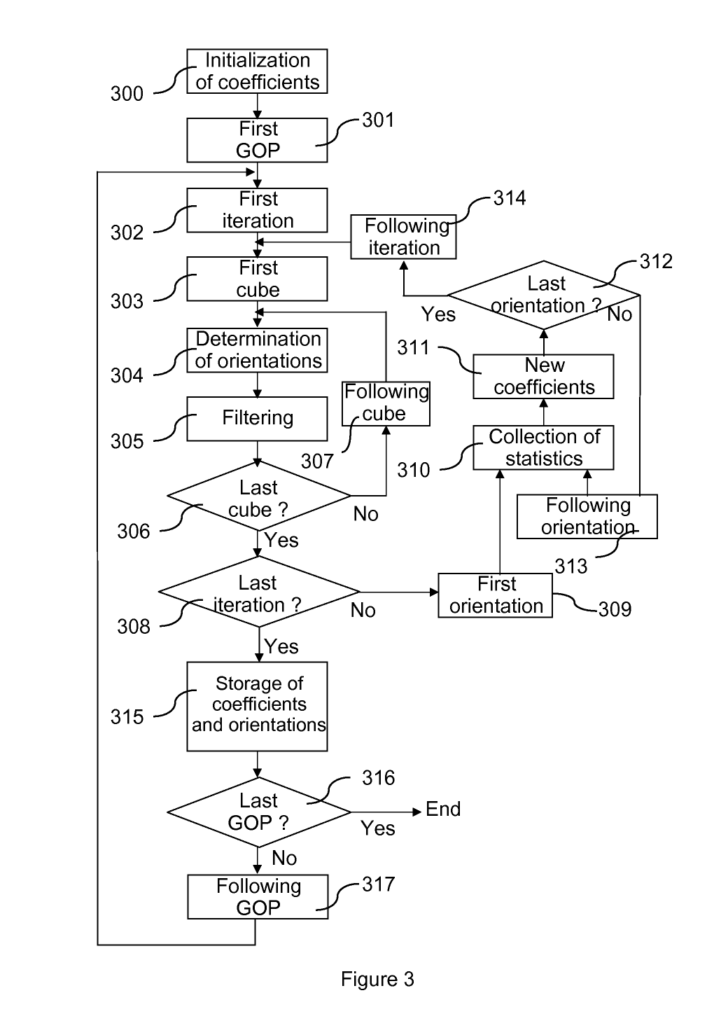

FIG. 3 shows, in the form of a logic diagram, steps implemented in a particular implementation of the filtering method and of the coding method that are the subjects of the present invention,

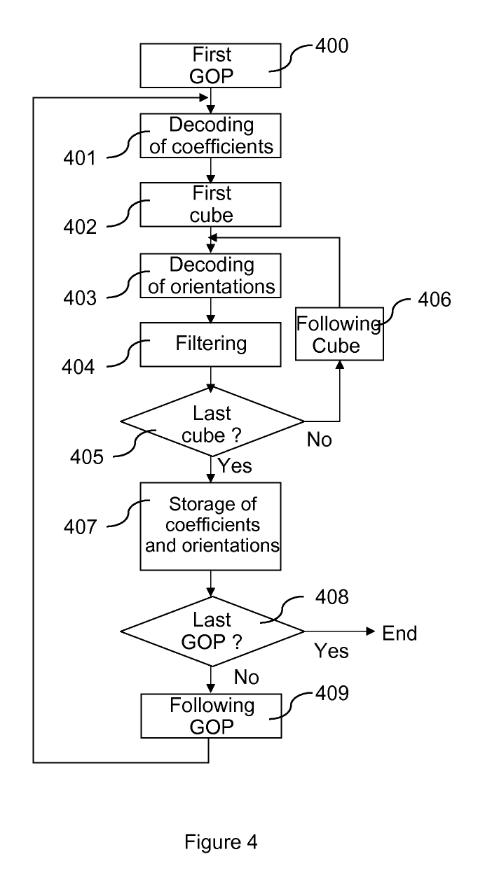

FIG. 4 shows, in the form of a logic diagram, steps implemented in a particular embodiment of the supersampling method and of the decoding method that are the subjects of the present invention, and

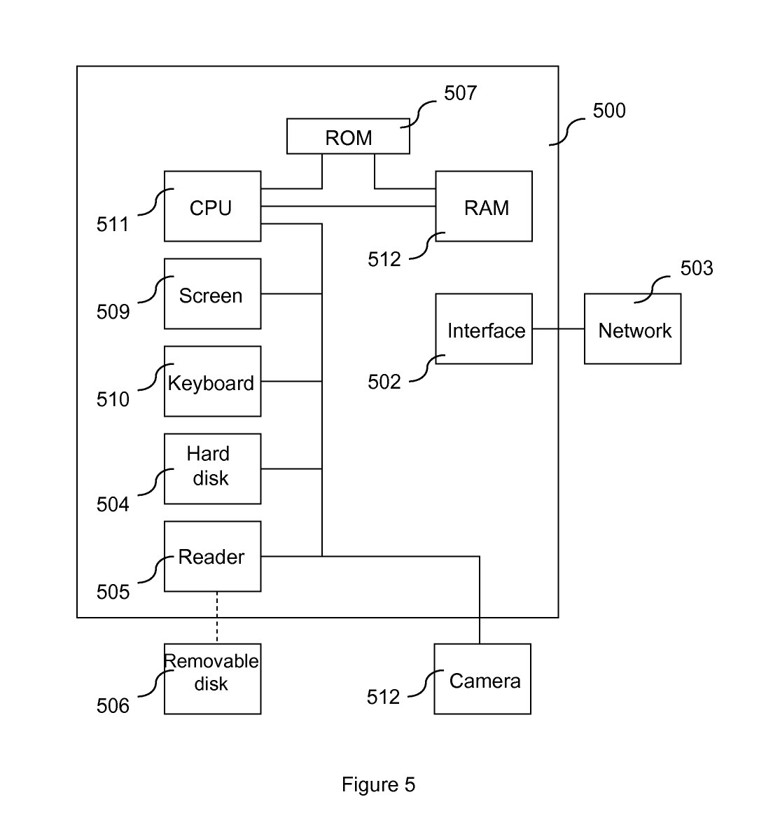

FIG. 5 shows, schematically, a particular embodiment of the devices that are the subjects of the present invention.

In order to describe the particular embodiments of the methods and devices that are the subjects of the present invention, a description of concepts that they implement is given below.

It should be stated first of all that a filter is defined by a support among a predetermined set of supports and a set of coefficient values corresponding to this support. Each support defines, for a sample to be filtered, the samples that have an influence on the results of the filtering. A coefficient value is allocated to each said sample defined by the support.

Preferentially, the filter supports used correspond to orientations of filters, also referred to as oriented filters. Each filter support is oriented along one axis, for example taken from among three axes, as illustrated in FIG. 1 for the case of pictures, each axis being able to be considered in one direction or the other, if the coefficients of the filters are not symmetrical, giving rise to six filter supports. Each filter then corresponds to a convolution in one dimension. More generally, it is possible to use filters chosen from a predetermined set in which the supports and coefficients are different. It should now be noted that the filters that will be able to have modified coefficients may be only a subset of this set of filters.

It should also be noted that the supersampling described below comprises two steps:
conventional interpolation, for example Lanczos or bilinear, and
the selection of an optimal orientation for a filter and effective coding in terms of rate/distortion costs of this selection.

The following description concerns pictures composed of samples called “pixels”. However, the present invention is not limited to this type of sample or signal but on the contrary extends to any type of sampled signal, in particular audio.

The least squares method aims to determine the filter coefficients that minimize the sum of the square errors between a target picture and a reference picture filtered with the filter the coefficients of which are to be determined. In the preferential embodiment described here, the reference picture is an interpolated picture, here a subsampled picture, coded, decoded and then supersampled.

This minimum being global, the partial derivatives of this sum according to the values of the coefficients are all zero, which gives a system of equations with terms dependent on the image, the unknowns of which are the coefficients.

To apply this method, the total filtering error is first of all expressed. For a given context C, for example a given filter orientation, and a set of coefficients, the filtering gives a pixel of coordinates (x,y), denoted “̂P (x,y)”, can be expressed as a convolution by a pair filter of length N+1:

̂P(x,y)=Σᵢ₌₀^{N}CᵢPᵢ(x,y)

an equation in which:
the coefficients Cᵢ, with i between 0 and N inclusive, are the values of coefficients of the filter and,
the terms Pᵢ(x,y) take the values of the signal to be filtered along the support of the filter applied, which depends on the orientation. For example, it is possible to have, for a vertical support with three samples:

P₀(x,y)=P(x,y)

P₁(x,y)=P(x+1,y)

P₂(x,y)=P(x−1,y)

The expression of the error E_{c} over all the pixels of the picture, in this context C, is thus:

E_{C}=Σ_{P(x,y) in C}(PO(x,y)−Σᵢ₌₀^{N}CᵢPᵢ(x,y))²

Where PO(x,y) represents the original value of the pixel of the target picture of coordinates (x,y).

This least squares method seeks to determine the coefficients Cᵢ, for i ranging from 0 to N, which minimize this error. The null derivatives are therefore sought, as a function of these coefficients, that is to say:

For any i integer between 0 and N inclusive,

dE_{c}/dCᵢ=0, that is to say again:

Σ_{P(x,y) in C}Pᵢ(x,y)[PO(x,y)−Σₖ₌₀^{N}CₖPₖ(x,y)]=0 or again:

Σᵢ₌₀^{N}Cᵢ[Σ_{P(x,y) in C}Pᵢ(x,y)Pᵢ(x,y)]=Σ_{P(x,y) in C}Pᵢ(x,y)PO(x,y)

Which is expressed by an invertible symmetrical matrix system.

$$[ \begin{matrix}{\sum }^{ } {P}_{0} ( x , y ) {P}_{0} ( x , y ) & … & {\sum }^{ } {P}_{0} ( x , y ) {P}_{N} ( x , y ) \\ {\sum }^{ } {P}_{j} ( x , y ) {P}_{0} ( x , y ) & & {\sum }^{ } {P}_{j} ( x , y ) {P}_{N} ( x , y ) \\ {\sum }^{ } {P}_{N} ( x , y ) {P}_{0} ( x , y ) & & {\sum }^{ } {P}_{N} ( x , y ) {P}_{N} ( x , y )\end{matrix} ] [ \begin{matrix}{C}_{0} \\ \\ {C}_{j} \\ \\ {C}_{N}\end{matrix} ] = [ \begin{matrix}{\sum }^{ } {P}_{0} ( x , y ) PO ( x , y ) \\ {\sum }^{ } {P}_{j} ( x , y ) PO ( x , y ) \\ {\sum }^{ } {P}_{N} ( x , y ) PO ( x , y )\end{matrix} ] \qquad ( 1 )$$

Where Σ represents Σ_{P(x,y) in C}

In preferential embodiments, the values of the coefficients of the filters are symmetrical (Cᵢ=C_{N-i}) and are 5 in number (that is to say N=4), as illustrated in FIG. 1. Consequently only three values of coefficients are to be determined.

Statistics produced during iteration of steps disclosed below make it possible to constitute the terms of the matrix M that participates in equation (1).

With regard to the determination of optimality, it is attempted to minimize a Lagrangian cost R+λ×D, where R is the rate of the information in relation to the filter used and D is the distortion between the original (or target) signal and the filtered signal. The compromise is controlled by the Lagrangian factor λ.

Here an entropic rate associated with the use of the filter in this situation and a way of determining the distortion associated with the use of this filter in this situation, for example the sum of the square errors mentioned above, are considered.

Thus, for each filter, the cost of the use thereof can be calculated and the optimal filter is the one that has the lowest cost.

Because the orientations determine the supports and the values of the filters of the coefficients affect the distortion calculated using this support, the orientations and values of the coefficients are conjointly optimized.

In FIG. 1, three supports of oriented filters 102, 104 and 106 are observed on a grid of points 108 that represent positions of pixels on horizontal lines 110.

FIG. 2 illustrates a system for processing digital image signals, for example pictures or videos, comprising a coding device 252, a transmission and/or storage unit 254 and a decoding device 256.

It can be observed, in FIG. 2, that, in a particular embodiment of the coding device that is the subject matter of the present invention, a source of pictures Si 201 supplies pictures Si of high spatial resolution (typically that of a digital camera or photographic apparatus picture sensor). In practice, this resolution is too high for transmission over a network and/or local storage.

This picture Si is supplied to a subsampler 200 and to an auxiliary information construction module 208. The subsampler 200 supplies a subsampled picture Sd, according to a known sub-sampling technique, for example with a Lanczos filter, to an optional compression unit 202. For example, in each dimension of the initial picture Si, the resolution is divided by two during the subsampling.

The optional compression unit 202 compresses the pictures Sd into pictures Sc according to a known compression format, for example H264, SVC or MPEG-2, for video data.

The signal Sc is decompressed by a decompression unit 204 in order to reconstruct the signal Sd′ which will be available, after decompression, on the decoding device side 256. It should be noted that, if the image Sd is not transmitted and/or stored in compressed form, the units 202 and 204 are withdrawn.

The signal Sd′ is next supersampled by a supersampling unit 206 in order to provide an image Sv with spatial resolution identical to that of the original image Si. The supersampling unit 206 preferentially uses a supersampling technique identical to that used by the decoding device 256. Preferentially, this supersampling technique corresponds to the subsampling technique implemented by the subsampler 200. The signal Si and the signal Sv, also referred to as the “source signal”, are used by an auxiliary information construction unit 208. The unit 208 determines sets of filters, each filter being defined by a support and a set of coefficient values, to be applied to the signal Sv to make it more similar, in the sense of distortion, to the original signal Si. The filtering information is coded as auxiliary information by the unit 208.

The auxiliary information is compressed, by a compression unit 210, before being combined with the compressed image Sc, by a multiplexer 212, in order to supply a coded signal to be stored and/or transmitted by the unit 254. The transmission typically takes place over a telecommunication network.

To retrieve the picture, the decoding device 256 receives the coded signal from the unit 254. This coded signal is first of all demultiplexed by a demultiplexer 214, which separates the compressed picture signal Sc and the auxiliary information signal. The compressed picture signal Sc is decompressed by a decompression unit 216 in order to form the reconstructed picture Sd′. This picture Sd′ is then supersampled by a supersampler 218 at the resolution of the picture Si in order to supply the picture Sv.

The auxiliary information signal is decompressed by a decompression unit 220. The picture Sv and the auxiliary information are processed conjointly by a processing unit 222 in order to supply a picture Sr that has the same resolution as the picture Si and an improved visual quality compared with the picture Sv.

The filtering steps applied during the coding by the processing 208 are illustrated in FIG. 3. During a step 300, the values of the filter coefficients are initialized. This step can be performed with inputs supplied by a user or default values. In preferred embodiments, the coefficients are initialized as follows:

C₀=−0.1

C₁=0.3

C₂=0.6

Because the coefficients are symmetrical:

C₃=C₁=0.3 and

C₄=C₀=−0.1.

These initial coefficient values are, at the start of the algorithm, the “current coefficients”.

In preferred embodiments, pictures consisting of video frames are processed. The corresponding picture sequence is divided into successive groups of pictures” (or “GOPs”). The number of pictures in the groups of pictures may be dynamic, that is to say variable in the sequence, or fixed, for example 16 pictures. During a step 301, the pictures in the first group of pictures are loaded into the processing memory of the auxiliary information construction unit 208, typically a microcontroller.

As mentioned above, the values of coefficients finally used are determined by means of a statistical information collection concerning the pictures. In addition, in preferred embodiments, entropic rates are updated from successive iterations of filters in order to obtain a correct cost determination. This leads to the use of a learning process both for the entropic rates and for the coefficients, in the embodiment described here. During a step 302, all the statistics used during the learning process are initialized.

It should noted that, in the case where several GOPs are processed, according to the variant, the values of the filter coefficients can be initialized to default values or be those found during the last iteration concerning the previous GOP.

In preferred embodiments, each GOP is divided into “parallelepipeds”, that is to say into sets of co-located blocks of W×H pixels of successive pictures of the GOP, here all the pictures of the GOP. In the remainder of the description, these sets are referred to as “cubes”.

During a step 303, the first cube is taken as the current cube. During a step 304, the optimal orientations for each pixel of the current tube are determined, to minimize the distortion between the filtered pixel coming from the picture Sv and the original pixel coming from the picture Si. The filtering is performed with the filter coefficients which are either obtained by the initialization step 300 if it is a case of the first iteration or by the filter coefficients obtained by the coefficient determination step 311 (described below) implemented during a previous iteration. Then, during a step 305, the current cube is filtered using these orientations and the current coefficient values.

During a step 306, it is determined whether the last cube of the current GOP has been processed. If not, during a step 307, the following cube is passed to and step 304 is returned to. If the result of step 306 is positive, during a step 308, it is determined whether the last iteration has been performed.

Because the final results of the learning process must be made available to the decoding device 256, it is necessary to determine whether the current iteration is the last. In some embodiments, at least one of the following criteria is used to determine whether the last iteration has been performed:
the current iteration number is compared with a maximum limit value, which has advantages in terms of length of processing,
it is determined whether the current iteration has given a reduction in cost,
it is determined whether the reduction in cost of the current iteration is greater than a predetermined value, and/or
it is determined whether the processing time has reach a predetermined value.

If the result of step 308 is positive, a step 315 is passed to.

If not, during a step 309, the pixels of the current GOP are separated into subsets of pixels for which the same filter orientation, that is to say the same support, is used. Then, as the current orientation, a first filter orientation is taken.

Then, from a step 310, statistical information is collected, comprising among other things:
the value of the pixel in the original picture (denoted PO(x,y) in equation (1)), and
the value of the pixels belonging to the support of the selected filter in the filtered picture (values denoted Pᵢ(x,y) in equation (1)).

This statistical information serves in particular to determine the optimal filter coefficients according to the method of least squares explained above, but can also be the occurrences within the signals to be coded in order to derive therefrom ideal entropic rates (and codes).

When all the statistical information has been collected, new coefficients for the first orientation can be calculated, during a step 311. In preferred embodiments, the method used is the method of least squares. These coefficients correspond to the current orientation.

Then, during a step 312, it is determined whether the last filter orientation has been processed. If not, during a step 313, an orientation that has not yet been processed is taken as the current orientation and step 310 is returned to. If the result of step 312 is positive, during a step 314, the following iteration is passed to.

When the last iteration has been reached, a set of coefficient values is associated with each orientation and an orientation is associated with each pixel of the current GOP. During step 315, the coefficient values associated with the current orientations of the GOP that have been determined during the last iteration of step 305 are compressed. These coefficient values enter the auxiliary information in order to be stored or transmitted with the data stream of the compressed subsampled picture.

It will also be noted that the orientations may also be coded, for example as disclosed in the patent application FR 2927744, using a set of predetermined contexts and a table of filter orientations associated with each value of the context.

During a step 316, it is determined whether the last GOP has been processed. If so, the coding process continues at the unit 210. Otherwise, during a step 317, the following group of pictures is passed to.

In FIG. 4, steps of decoding the picture sequence coded during the steps illustrated in FIG. 3 can be seen.

During a step 400, the picture sequence is divided into groups of pictures (“GOPs”) in the same way as during step 301. Then a first GOP is taken as the current GOP, disclosed for step 301. During a step 401, the values of the coefficients of the filters associated with each orientation are decoded, using the decoding method corresponding to the coding method used during step 315. During a step 402, the current GOP is divided into cubes and a first cube is taken as the current cube. During a step 403, the supports, here the orientations, of the filters used for the pixels of the current cube are decoded. During a step 404, each pixel of the current cube is filtered with the oriented filter that is associated with it and with the filter coefficient values associated with this orientation.

In the case where a predetermined set of contexts has been used for coding the orientations of the filters used, as disclosed in the application FR 2927744, it is necessary to decode the context and a table of filter orientations associated with each value of the context. In order to determine the orientation of the filter associated with each pixel, the context function of the pixel in question is decoded and the filter orientation is read in the table of orientations.

During a step 405, it is determined whether the current cube is the last cube. If not, during a step 406, the following cube is taken as the current cube and step 403 is returned to.

If the result of step 405 is positive, during a step 407 the processed frames are saved and, during a step 408, it is determined whether the last GOP of the picture sequence has been processed. If so, decoding is ended. Otherwise, during a step 409, the following GOP is taken as the current GOP and step 401 is returned to.

A particular embodiment of the device that is the subject matter of the present invention is illustrated in FIG. 5. This device 500 can be based on a computer connected to peripherals, for example a digital camera 508 or a camcorder (camera with recorder). The device 500 has an internal storage unit, such as a hard disk 504. It can also have means 505 of reading removable information carriers 506, for example compact disks or diskettes. The removable carrier 506, a read only memory 507 or a non-volatile memory 512 and/or the storage unit 504 can store executable codes implementing at least one of the filtering, coding, supersampling or decoding methods that are the subjects of the present invention. The device 500 also comprises a communication interface 502 for communicating over a communication network 503, typically the internet. The executable code can also be received by means of this network 503.

A central processing unit, or CPU, 511 executes the executable code and performs the steps of at least one of the methods that are the subjects of the present invention.

The device 500 can also incorporate a keyboard 510 and a screen 509, to display pictures being processed or to form a user interface with the keyboard 510, possibly to be replaced or supplemented by a pointing device, for example a mouse, or a touch screen (not shown).

A communication bus 501 affords the transmission of data and information between the components of the device and coordination thereof.

The inventors have determined that, by implementing the preferred embodiments of the method that is the subject matter of the present invention, an improvement of 0.3 dB could be observed.

1.-14. (canceled)

15. A method of filtering a group comprised of one or more samples of a digital signal, wherein a filter is defined by a support among a predetermined set of supports and a set of coefficients corresponding to such support, and wherein such support defines samples associated with each sample to be filtered, the method comprising:
initializing current values of coefficients associated with each filter support;
determining a filter support to be applied to each sample in the group of samples;
filtering the samples in the group of samples using the filter support determined in the determining step and the current coefficient values;
obtaining updated current values of coefficients associated with each filter support, wherein for each filter support, current values are updated by (i) obtaining, from the samples in the group, a subgroup of samples comprising each sample in the group of samples corresponding to such filter support, and (ii) calculating optimal values of the coefficients of the filter associated with such filter support according to a predetermined criterion applied to the subgroup of samples; and
repeatedly iterating the determining step and the filtering step for at least two iterations for each group of samples;
wherein in each iteration as from the second, as current coefficient values, optimal values of coefficients obtained during a previous iteration are used.

16. The method according to claim 15, wherein the samples correspond to picture pixels, and wherein each iteration is performed for a group of one or more pictures.

17. The method according to claim 16, wherein in the initializing step, current values of the coefficients are initialized to optimal values determined for at least one picture in a group not containing the picture to be filtered.

18. The method according to any one of claim 16 or 17, wherein in each iteration, the pictures are processed by plural groups in which each group is comprised of a plurality of successive pictures.

19. The method according to claim 18, wherein in each iteration, co-located blocks in successive pictures in the same group of pictures are processed successively.

20. The method according to claim 19, wherein supports in the predetermined set of supports correspond to filter orientations.

21. The method according to any one of claim 15 to 17, wherein supports in the predetermined set of supports correspond to filter orientations.

22. The method according to any one of claim 15 to 17, wherein the supports in the predetermined set of supports each have the same number of samples.

23. The method according to any one of claim 15 to 17, wherein at least one iteration further comprises collecting statistics concerning the filtered samples and target values for the filtered samples, wherein the collected statistics are used in calculating optimal values of the filter coefficients.

24. The method according to claim 23, wherein in calculating optimal values of the filter coefficients, the predetermined criterion corresponds to minimization of the mean square error between the values of the filtered samples and the target values of the filtered samples for a set of samples.

25. The method according to any one of claim 15 to 17, wherein in calculating optimal values of the filter coefficients, the predetermined criterion corresponds to minimization of the mean square error between the values of the filtered samples and target values of the filtered samples for a set of samples.

26. The method according to claim 15, further comprising:
coding a subsampled signal representing the samples; and
coding, in a auxiliary information unit, supports and coefficients obtained during the last iteration of the filtering method.

27. A device for filtering a group comprised of one or more samples of a digital signal, wherein a filter is defined by a support among a predetermined set of supports and a set of coefficients corresponding to such support, and wherein such support defines samples associated with each sample to be filtered, the device comprising:
at least one storage device which stores the digital signal, the filters, and computer-executable code for execution by a processor;
a processor programmed to execute the computer-executable code stored in the storage device, wherein execution of the computer-executable code by the processor causes the processor to perform steps comprising:
initializing current values of coefficients associated with each filter support;
determining a filter support to be applied to each sample in the group of samples;
filtering the samples in the group of samples using the filter support determined in the determining step and the current coefficient values;
obtaining updated current values of coefficients associated with each filter support, wherein for each filter support, current values are updated by (i) obtaining, from the samples in the group, a subgroup of samples comprising each sample in the group of samples corresponding to such filter support, and (ii) calculating optimal values of the coefficients of the filter associated with such filter support according to a predetermined criterion applied to the subgroup of samples; and
repeatedly iterating the determining step and the filtering step for at least two iterations for each group of samples;
wherein in each iteration as from the second, as current coefficient values, optimal values of coefficients obtained during a previous iteration are used.

28. The device according to claim 27, further comprising means of coding, in an auxiliary information unit, supports and coefficients obtained during the last iteration.

29. A non-transitory computer-readable storage medium which retrievably stores computer-executable code which when executed by a processor causes the processor to perform a method according to any one of claim 15 to 17.
